(19) United States
(12) Patent Application Publication
(10) Pub. No.: US 2007/0033227 A1
(43) Pub. Date: Feb. 8, 2007

(54) System and method for rescoring names in mailing list

(76) Inventors: Robert G. Gaito, Troy, NY (US); Michael Kosiba, Oak Park, IL (US)

Correspondence Address: HOFFMAN WARNICK & D'ALESSANDRO, LLC, 75 STATE STREET, 14TH FLOOR, ALBANY, NY, 12207, US

(21) Appl. No.: 11/369,304

(22) Filed: Mar. 7, 2006

Related U.S. Application Data
(60) Provisional application No. 60/706,270, filed on Aug. 8, 2005.

(51) Int. Cl. G06F 17/00

(52) U.S. Cl. 707/104.1

(57) ABSTRACT

A system and method for rescoring records in a mailing list, wherein each of the records in the mailing list is associated with a common predefined score. A system is provided that includes a merge system for merging data from a database to records in the mailing list to create a merged mailing list; an analysis and modeling system for analyzing the merged mailing list, identifying a set of variables, and generating a model based on the set of variables; and a rescoring system for applying the model to each record in the merged mailing list in order to rescore each record.

This application claims the benefit of co-pending U.S. Provisional Application Ser. No. 60/706,270 filed on Aug. 8, 2005, entitled “I-score solution for direct marketers,” which is hereby incorporated by reference.

### FIELD OF THE INVENTION

The invention relates generally to scoring mailing lists for direct marketing, and more particularly relates to a system and method of enhancing projected sales per book (PSPB) calculations to allow a marketer to create and score segments within a mailing list.

### BACKGROUND OF THE INVENTION

Due to today's highly competitive marketplace, large amounts of money must typically be spent by direct marketers on promotions to generate sales. This is particularly the case for catalog driven businesses in which the cost of producing and mailing catalogs is substantial. Accordingly, understanding the likely return for a catalog mailing sent to a particular mailing list allows direct marketers to more effectively utilize their marketing resources for a marketing campaign.

Generally, most catalog/retail marketers create a finite amount of groups (often referred to as lists) for each respective mailing. Lists are generally separated into two groups: buyers and non-buyers. Each of these lists contains a large number of names that have homogeneous characteristics by nature within the list. For example, across a buyer universe, marketers may create lists based upon RFM (Recency, i.e., time since last purchase, Frequency of purchases, Monetary, i.e., amount of purchases), or based upon a score of a statistical model. Across the non-buyer universe, lists are created based on source of name (e.g., where is list rented from) or based on recent contact (e.g., names of individuals who have made inquiries). There are other methods for developing lists but these are the most common in the direct marketing industry.

The concept of “projected sales per book” (PSPB) provides a commonly used metric in the industry for rating or ranking lists. Marketers assign a PSPB value to a list based upon the actual performance of each list in a prior mailing (or a series of prior mailings). This actual performance is generally projected to the whole list (as if all of the names have been mailed in it) and is therefore is a measurement indicating how much each name mailed will spend (on average) within that list.

For example, a first list LIST_A of 100,000 households may have a PSPB of $0.95, while a second list LIST_B of 200,000 households may have a PSPB of $0.80. Thus, the assumption is that for each catalog sent, the company, on average, will receive $0.95 in revenue from households in LIST_A and $0.85 in revenue from households in LIST_B. Accordingly, the marketer will favor those households in LIST_A. However, while the PSPB concept is useful, it does not always provide a level of detail necessary for the marketer. For instance, consider the case where the marketer wants to send out 200,000 catalogs. Assuming 100,000 go to the higher performing households in LIST_A, the PSPB provides no guidance regarding which households in LIST_B should receive the remaining 100,000.

Unfortunately, there currently exist no efficient systems for further discerning performance among individual households in a list. In other words, among the 200,000 households in LIST_B, there is currently no effective way of identifying the high performers.

Accordingly, a need exists for a system and method that can further breakdown PSPB values within a list to identify and segment projected performances within the list.

### SUMMARY OF THE INVENTION

The present invention addresses the above-mentioned problems, as well as others, by providing a system and method for enhancing PSPB calculations to identify and segment projected performance within a list.

In a first aspect, the invention provides a system for processing records in a mailing list, wherein each of the records in the mailing list is associated with a common predefined score, the system comprising: a merge system for merging data from a database to records in the mailing list to create a merged mailing list; an analysis and modeling system for analyzing the merged mailing list, identifying a set of variables, and generating a model based on the set of variables; and a rescoring system for applying the model to each record in the merged mailing list in order to rescore each record.

In a second aspect, the invention provides a computer program product stored on a computer usable medium for processing records in a mailing list, wherein each of the records in the mailing list is associated with a common predefined score, the computer program product comprising: program code configured for merging data from a database to records in the mailing list to create a merged mailing list; program code configured for analyzing the merged mailing list, identifying a set of key variables, and generating a model based on the set of key variables; and program code configured for applying the model to each record in the merged mailing list in order to rescore each record.

In a third aspect, the invention provides a method of processing records in a mailing list, wherein each of the records in the mailing list is associated with a common predefined score, the method comprising: merging data from a database to records in the mailing list to create a merged mailing list; analyzing the merged mailing list, identifying a set of key variables, and generating a model based on the set of key variables; and applying the model to each record in the merged mailing list in order to rescore each record.

In a fourth aspect, the invention provides a method for deploying an application for rescoring records in a mailing list, comprising: providing a computer infrastructure being operable to: merge data from a database with records in the mailing list to create a merged mailing list; analyze the merged mailing list, identify a set of key variables, and generate a model based on the set of key variables; and apply the model to each record in the merged mailing list in order to rescore each record.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a scoring system in accordance with the present invention.

FIG. 2 depicts a process for merging data into records from a mailing list.

FIG. 3 depicts a process for transforming merged data into enhanced predictions for names in a mailing list.

FIG. 4 depicts a model used to transform data records in a mailing list.

FIG. 5 depicts a segmented output containing enhanced predictions for a set of lists.

### DETAILED DESCRIPTION OF THE INVENTION

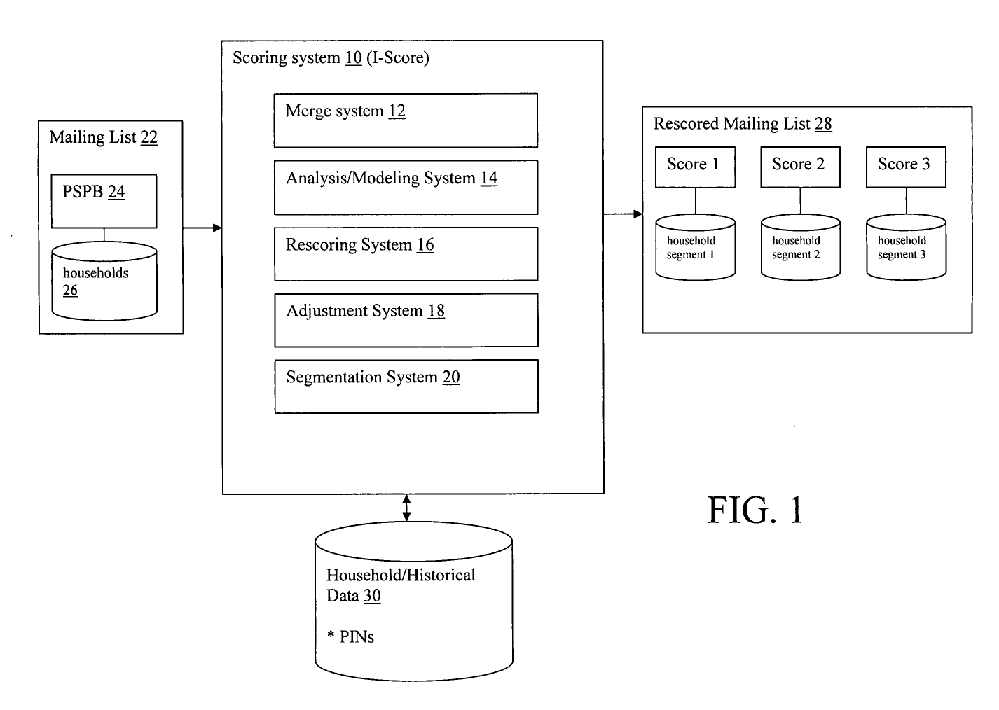

Referring now to drawings, FIG. 1 depicts a scoring system 10 (also referred to herein as I-Score) that processes a mailing list 22 and outputs a rescored mailing list 28. In accordance with the present embodiment, the inputted mailing list 22 includes a list of households 26 that are associated with a “projected sales per book” (PSPB) 24. In other words, each household 26 in the mailing list 22 has a common predefined score or PSPB 24. As noted above, the use of PSPB values for scoring mailing lists 22 is regularly used in the direct marketing industry. The rescored mailing list 28 provides adjusted scores for each household record in the mailing list 22.

Note that while FIG. 1 depicts an embodiment wherein only a single mailing list 22 is processed, mailing list 22 may be part of a larger set of lists wherein each list has a different PSPB. For instance, a first list may include “best buyers” having a PSPB of $2.04, a second list may include “good buyers” having a PSPB of $1.27, a third list may include “fair buyers” having a PSPB of $1.00, and a fourth list may include “poor buyers” having a PSPB of $0.77. Such a scenario is common in the industry.

As noted, scoring system 10 processes each such mailing list 22 and generates a rescored mailing list 28 in which the PSPB 24 of each household 26 in the mailing list 22 is “rescored” to provide more meaningful prediction data. As opposed to assigning a score to the entire mailing list 22, scoring system 10 provides a system in which each individual household 26 is analyzed and rescored, e.g., with an enhanced PSPB score. Thus, while the PSPB 24 for the inputted mailing list 22 may be $1.00, some households 26 will be rescored with values of more than $1.00, while others will be rescored with values of less than $1.00. From this information, the direct marketer will be able to determine the high performers from the low performers in the inputted mailing list 22.

Once all the households 26 in a mailing list 22 have been rescored, the households 26 can also be segmented into groups. For instance, in the embodiment shown in FIG. 1, the rescored mailing list 28 is divided into three segments, including household segment 1 having Score 1, household segment 2 having Score 2, and household segment 3 having Score 3. In a typical application, Scores 1, 2 and 3 represent PSPB ranges, e.g., Score 1<$0.90; $0.91<Score 2<$1.10, Score 3>$1.11. By segmenting the data in the fashion, the direct marketer can group households based on projected performance.

In order to generate rescored mailing list 28 from an inputted mailing list 22, scoring system 10 includes: a merge system 12 for merging data from existing household/historical data 30 with the households 26 listed in the mailing list 22; an analysis/modeling system 14 for analyzing the merged data and creating a model based on a set of key variables; a rescoring system 16 for applying the model to the data to individually rescore each household 26; an adjustment system 18 that ensures that the average of the all the recalculated scores is relatively comparable to the original PSPB 24; and a segmentation system 20 for segmenting the rescored households into defined segments.

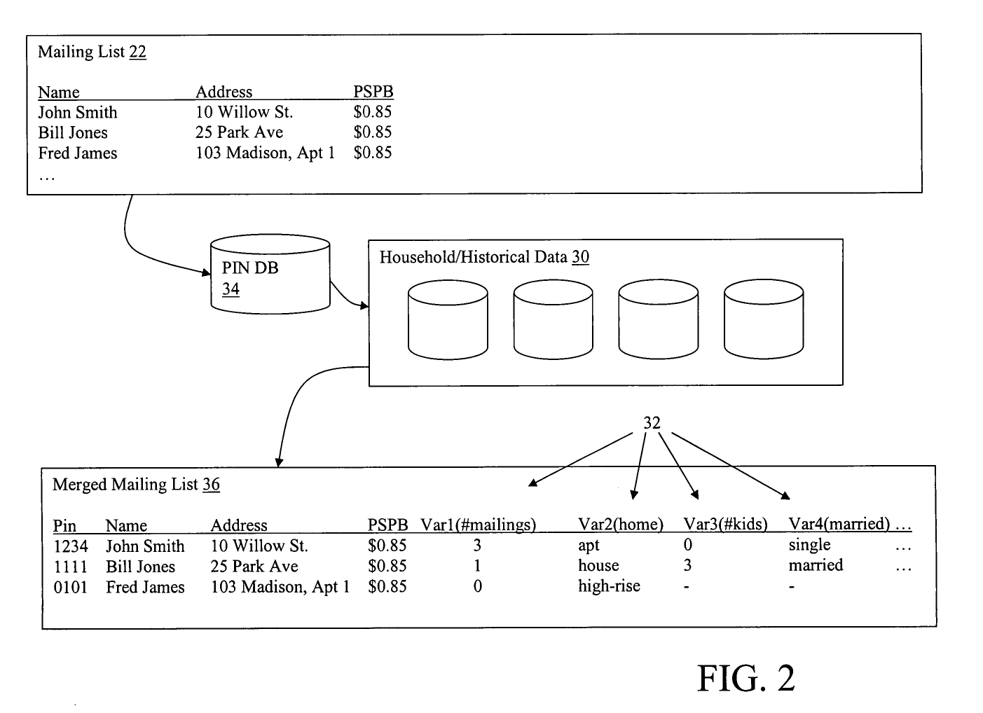

FIG. 2 depicts a process for merging data from a mailing list 22 into a merged mailing list 36. As can be seen, the inputted mailing list 22 includes a limited amount of information, namely a list of households (e.g., names and addresses), each having the same PSPB of $0.85. The resulting merged mailing list 36 includes additional information for each household. Each additional piece of information is identified with a variable 32, e.g., # of mailings previously sent to the household, type of home, # kids, marital status, etc. Obviously, the number and type of variables 32 incorporated into the merged mailing list 36 can vary without departing from the scope of the invention. In this illustrative embodiment, the merged mailing list 36 may be created using a PIN database 34 that links each household in the mailing list 22 to a unique and persistent personal identification number (PIN). Depending on whether the household is known, an existing PIN is located for the household or a new PIN must be created for the household. Assuming an existing PIN is located, data associated with the PIN can be extracted from the household/historical data 30. Using the PIN in this manner allows for fast retrieval of the household/historical data 30. A description of such a system is provided in U.S. patent application Ser. No. 10/091,956, entitled CONTACT RELATIONSHIP MANAGEMENT SYSTEM AND METHOD, filed on Mar. 6, 2002, which is hereby incorporated by reference. Alternatively, non-PIN data sources could also be used to augment the information in the inputted mailing list 22. In either case, such data may include information from previous mailings, demographic information, post office records, census data, etc.

It should be understood that the database of household/historical data 30 may be implemented, stored, and retrieved in any manner, i.e., it may comprise a single database, a set of databases, data distributed across a network, relational databases, etc.

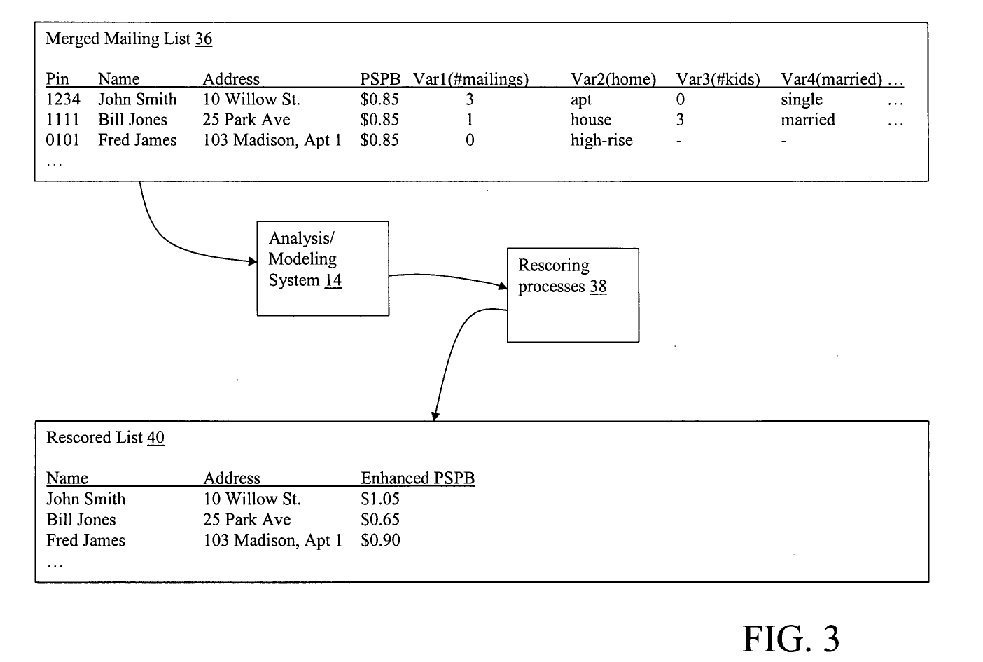

As shown in FIG. 3, once a merged mailing list 36 is created, analysis/modeling system 14 can be utilized to create a model. In an illustrative embodiment described herein, the modeling process begins by first defining a dependent variable to be the measurement that is to be predicted, namely dollars spent on the marketers merchandise as a result of being promoted/mailed, i.e., an enhanced PSPB or simply “rescore.” The dependent variable is created at the household (or also referred to as ‘name’) level.

Next, a subset of “independent” variables from the merged mailing list 36 must be identified that will be used to make the prediction. In other words, a process is utilized to identify a subset of variables from all possible variables that will most likely make good predictors. When considering the candidate list of independent variables, any variables that have already been used in creating the inputted mailing list 22 should be discarded. Independent variables are also created at the household (or ‘name’) level.

Once the independent variables have been identified, a modeling process can commence. Each independent variable is analyzed based on its ability to discriminate the dependent variable (dollars spent). Once these performance trends have been analyzed (using various statistical techniques), each of the independent variables (generally continuous in nature) are partitioned into new independent variables (categorical in nature). These new independent variables now become the final candidate set, or “key” variables.

One of the features that set this process apart from all other marketing solutions is the ability to optimize the adjustment of the PSPB provided from the marketer. This requires the modeling process to take the PSPB into account as part of the solution. However, including the PSPB as a variable in the final model equation may not be an “ideal fit” since the PSPB from the marketer includes an inherent bias due to many effects (e.g., seasonality, over-estimation of list performance, etc.). Therefore, a similar variable may be used that can both mirror the tracking performance of the PSPB at the list level and also provide an unbiased estimate. In one illustrative embodiment, a new variable is created called actual sales per book mailed (ASPB).

The ASPB is created by summarizing the dependent variable (dollars spent) to the list level and then dividing that total by the number of names mailed within that list. This process is done for every list in the mailings that is being used in the modeling process. The ASPB is then the first variable included in the model.

After the ASPB is included in the model, the list of new independent variables can be considered. Multiple regression runs (using statistical procedures) may be done in attempt to find the best set of independent variables. Generally, the number of independent variables to be included in the model may range from ten to fifteen, although any number is possible.

After the model is constructed, the ASPB must be replaced with the PSBP before deployment of the model (rescoring). Once again, the PSPB is considered the marketer's value of the household before rescoring (and is always the first independent variable in the model) and all other independent variables in the model serve as adjustments of the PSPB.

Each independent variable included in the model has, by definition, a numerical value associated with it, often referred to as the parameter estimate (which can either be positive or negative). This parameter estimate must be transformed into a percentage so that all applicable households can be accurately scored within a wide range of PSPB values. This is done by first identifying the actual sales per book mailed of the whole model universe. By summarizing the dependent variable (dollars spent) across all of the names in the model universe and then dividing that total by the number names mailed within the modeling universe, the actual sales per book mailed of the whole model universe (ASPBU) can be determined. Every parameter estimate (with the exception of the PSPB estimate) then gets transformed into a percentage by taking each respective parameter estimate and dividing it by the ASPBU. The end result yields an equation that looks like the following:
Rescore=(PSPB*Estimate)+((PSBP)*(Variable 1 Estimate))+((PSPB)*(Variable 2 Estimate))+ . . . +((PSPB)*(Variable N Estimate))

where ‘Variable 1 Estimate’ to ‘Variable N Estimate’ are values ranging from −0.99 to 0.99.

It is important to note that all variable estimates (1 to N) will only get the adjustments invoked when the conditions of the respective independent variable result in a true statement (e.g., if gender is male). All names/households within the applicable modeling universe will then get rescored. An example of this is shown in the rescored list 40 in FIG. 3.

Once all of the applicable households have been rescored, it may be necessary for the adjustment system 18 (FIG. 1) to introduce an adjustment factor to each score. This may for example be determined by partitioning the scoring universe by the PSPB into equal deciles (e.g., ten groups). Depending on the quantity of the scoring universe, more or less partitions may be needed. For each partition, the PSPB average and rescore average are calculated. If these averages have a considerable difference, an adjustment factor will need to be imposed. The adjustment factor will be determined such that the average of the rescores multiplied by the adjustment factor will be equal to PSPB average. This adjustment factor will be created for each partition and therefore every partition will have a unique adjustment factor.

A principle behind the adjustment factor concept is to use the PSPB as a series of bounds to which the scores are governed by. These bounds exemplify a goal of the solution: to provide a bounded solution that maximizes the amount of PSPB discrimination given any range of PSPB values that a marketer provides.

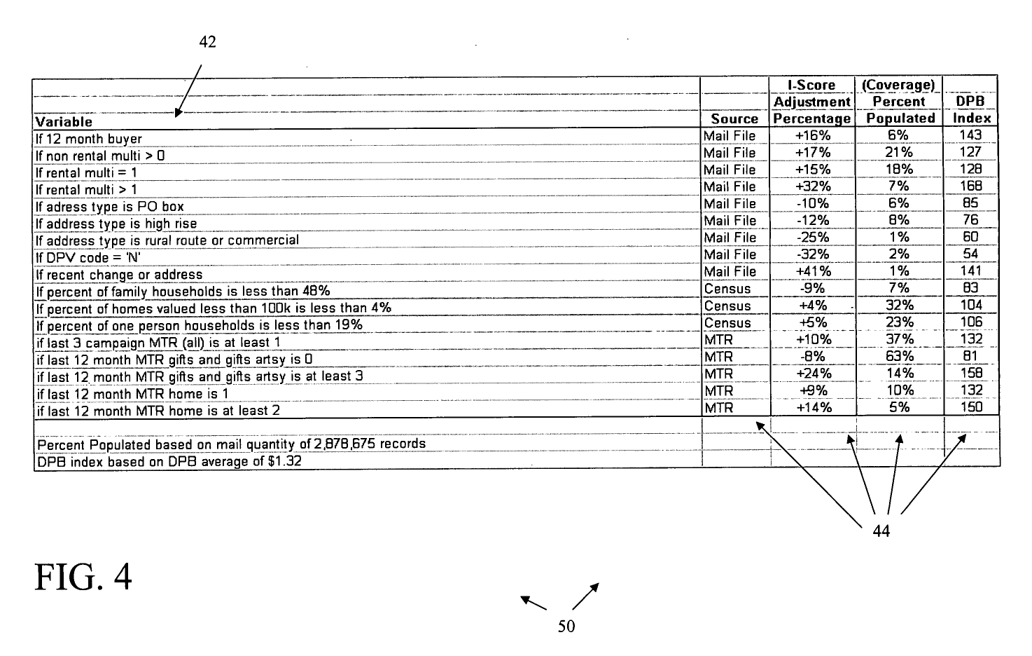

FIG. 4 depicts an example of a model 50 that is based on a set of variables 42. Variables identified and used in this model include whether the household includes a buyer within the last 12 months, whether they rent/own, whether they are a multiple buyer, address type, etc. Included in the model 50 is related information including the source of the variable (e.g., mail file, census, match to rental “MTR” file, etc.), and adjustment percentage for each variable, coverage percentage for each variable (e.g., how many households in the mailing list 22 have this variable), and a dollar per book (DPB) index. The DPB index is a statistic that illustrates how well each variable predicts ASPBU (of the entire modeling universe) independently—a value of 100 is average, a value greater than 100 is above average, and less than 100 is below average.

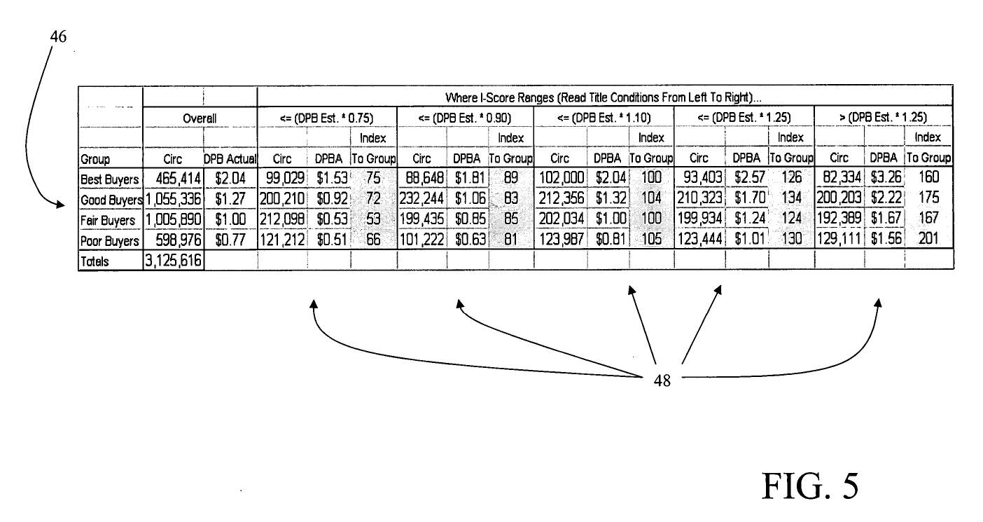

FIG. 5 depicts an illustrative report for a set of segmented mailing lists processed in accordance with the present invention. In this case, four mailing lists 46 (best buyers, good buyers, fair buyers and poor buyers) were inputted into the scoring system 10 (FIG. 1). Records in each mailing list were then rescored and segmented into one of five segments 48 (n<=0.75, 7.75<n<=0.90, 0.90<n<=1.10, 1.10<n<=1.25, and >1.25). In this example, the score for each list is shown as dollars per book actual (DPBA). As can be seen, each list is broken down into segments that provide a more precise prediction of performance. For instance, for the 598976 poor buyers, which had an overall score of $0.77, a high performing segment of 129,111 households has been identified that have a DBPA of $1.56. Similarly, for the 465,414 best buyers, which had an overall score of $2.04, a low performing segment of 99,029 households is identified that have a DPBA of $1.53. Thus, a segment of the poor buyers is actually projected to outperform a segment of the best buyers. The scoring system 10 allows the user to identify such segments and make better mailing decisions.

As noted above, the PSPB is developed by the marketer and is constructed such that all available names are mailed within that list. However, as a by-product of selecting names using the modeling tool and systems described herein, some of the records will not be mailed for many of the inputted mailing lists. This will create a problem for the marketer with respect to gauging an accurate reflection of the future PSPB of a list. To eliminate the bias that is created for such lists, a standardization factor may be generated. By applying this factor, a marketer will be able adjust the actual performance of each list so that it is representative of all names in the list (and not just the names that were mailed). This standardization factor is created at the list level by taking the average score of all names within the list and dividing that total by the average score of all names that were mailed within the list. The result will yield a value less than or equal to one (it will be one if all names were mailed). The marketer can then multiply this factor to their actual performance on a list by list basis to create a new unbiased PSPB to use for a future mailing.

In general, scoring system 10 may be implemented on any type of computer system. Moreover, scoring system 10 could be implemented as part of a client and/or a server. Such a computer system generally includes a processor, input/output (I/O), memory, and bus. The processor may comprise a single processing unit, or be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, memory may reside at a single physical location, comprising one or more types of data storage, or be distributed across a plurality of physical systems in various forms.

I/O may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Additional components, such as cache memory, communication systems, system software, etc., may be incorporated into the computer system.

Access to the computer system may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system comprising a scoring system 10 could be created, maintained and/or deployed by a service provider that offers the functions described herein for customers. That is, a service provider could offer to provide scoring of mailing lists as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for processing records in a mailing list, wherein each of the records in the mailing list is associated with a common predefined score, the system comprising:
a merge system for merging data from a database to records in the mailing list to create a merged mailing list;
an analysis and modeling system for analyzing the merged mailing list, identifying a set of variables, and generating a model based on the set of variables; and
a rescoring system for applying the model to each record in the merged mailing list in order to rescore each record.

2. The system of claim 1, wherein each record in the mailing list includes a household.

3. The system of claim 1, wherein the common predefined score is a projected sales per book value (PSPB).

4. The system of claim 1, wherein the database includes historical and household data that can be linked to records in the mailing list.

5. The system of claim 4, wherein the merge system utilizes a personal identification number to link historical and household data to records in the mailing list.

6. The system of claim 1, wherein the analysis and modeling system uses regression to identify the set of variables.

7. The system of claim 3, wherein the model is of the form:
rescore=(PSPB*Estimate)+((PSBP)*(Variable 1 Estimate))+((PSPB)*(Variable 2 Estimate))+ . . . +((PSPB)*(Variable N Estimate)),
wherein Estimate and Variable n Estimate, wherein n=1 to N, are values ranging from −0.99 to 0.99.

8. The system of claim 1, further comprising an adjustment system for ensuring that an average of each rescored value is comparable to the common predefined score.

9. The system of claim 1, further comprising a segmentation system for allowing a rescored mailing list to be divided into a set of predefined segments based on projected performance.

10. A computer program product stored on a computer usable medium for processing records in a mailing list, wherein each of the records in the mailing list is associated with a common predefined score, the computer program product comprising:
program code configured for merging data from a database to records in the mailing list to create a merged mailing list;
program code configured for analyzing the merged mailing list, identifying a set of key variables, and generating a model based on the set of key variables; and
program code configured for applying the model to each record in the merged mailing list in order to rescore each record.

11. The computer program product of claim 10, wherein each record in the mailing list includes a household.

12. The computer program product of claim 10, wherein the common predefined score is a projected sales per book (PSPB) value.

13. The computer program product of claim 12, wherein the model is of the form:
rescore=(PSPB*Estimate)+((PSBP)*(Variable 1 Estimate))+((PSPB)*(Variable 2 Estimate))+ . . . +((PSPB)*(Variable N Estimate)),
wherein Estimate and Variable n Estimate, wherein n=1 to N, are values ranging from −0.99 to 0.99.

14. The computer program product of claim 10, wherein the database includes historical and household data that can be linked to records in the mailing list.

15. The computer program product of claim 14, wherein a personal identification number is used to link historical and household data to records in the mailing list.

16. The computer program product of claim 10, wherein regression is used to identify the set of key variables.

17. The computer program product of claim 10, further comprising program code configured for ensuring that an average of each rescored value is comparable to the common predefined score.

18. The computer program product of claim 10, further comprising program code configured for allowing a rescored mailing list to be divided into a set of predefined segments based on projected performance.

19. A method of processing records in a mailing list, wherein each of the records in the mailing list is associated with a common predefined score, the method comprising:
merging data from a database to records in the mailing list to create a merged mailing list;
analyzing the merged mailing list, identifying a set of key variables, and generating a model based on the set of key variables; and
applying the model to each record in the merged mailing list in order to rescore each record.

20. The method of claim 19, wherein each record in the mailing list includes a household.

21. The method of claim 19, wherein the common predefined score is a projected sales per book (PSPB) value.

22. The method of claim 21, wherein the model is of the form:
rescore=(PSPB*Estimate)+((PSBP)*(Variable 1 Estimate))+((PSPB)*(Variable 2 Estimate))+ . . . +((PSPB)*(Variable N Estimate)),
wherein Estimate and Variable n Estimate, wherein n=1 to N, are values ranging from −0.99 to 0.99.

23. The method of claim 19, wherein the database includes historical and household data that can be linked to records in the mailing list.

24. The method of claim 23, wherein a personal identification number is used to link historical and household data to records in the mailing list.

25. The method of claim 19, wherein regression is used to identify the set of key variables.

26. The method of claim 19, further comprising the step of ensuring that an average of each rescored value is comparable to the common predefined score.

27. The method of claim 19, further comprising program the step of dividing the rescored mailing list into a set of predefined segments based on projected performance.

28. A method for deploying an application for rescoring records in a mailing list, comprising:
providing a computer infrastructure being operable to:
merge data from a database with records in the mailing list to create a merged mailing list;
analyze the merged mailing list, identify a set of key variables, and generate a model based on the set of key variables; and
apply the model to each record in the merged mailing list in order to rescore each record.
